(19) United States
(12) Patent Application Publication
(10) Pub. No.: US 2026/0024995 A1
(43) Pub. Date: Jan. 22, 2026

(54) PROBABILISTIC SOLAR GENERATION FORECASTING FOR RAPIDLY CHANGING WEATHER CONDITIONS

(71) Applicants: Sara Eftekhamejad, Manlius, NY (US); Cheng Lyu, Syracuse, NY (US)

(72) Inventors: Sara Eftekhamejad, Manlius, NY (US); Cheng Lyu, Syracuse, NY (US)

(73) Assignee: Syracuse University, Syracuse, NY (US)

(21) Appl. No.: 19/224,168

(22) Filed: May 30, 2025

Related U.S. Application Data
(60) Provisional application No. 63/653,648, filed on May 30, 2024.

(51) Int. Cl. H02J 3/00; G06N 3/0442; G06N 3/08; H02J 3/38

(52) U.S. Cl. CPC H02J 3/004; G06N 3/0442; G06N 3/08; H02J 3/381; H02J 2203/20; H02J 2300/24

(57) ABSTRACT

A method and system for probabilistic solar generation forecasting under rapidly changing weather conditions integrate copula theory with an extreme gradient tree boosting (XGBoost) classifier to enhance forecast accuracy. Historical weather data is partitioned into meteorological clusters, and bivariate copulas analyze spatiotemporal correlations to select optimal features. Multivariable Vine and Gaussian copulas model variable dependencies, with an XGBoost classifier dynamically selecting the optimal copula based on real-time weather conditions. Synthetic weather data, generated using the selected copula, captures uncertainties and is applied to a trained XGBoost regression tree to produce probabilistic forecasts. The method achieves up to 60% higher accuracy than conventional models under non-sunny conditions, leveraging Gaussian Kernel Density Estimation and Huber loss for robustness. The system supports real-time grid operations, offering reliable solar power predictions for diverse weather scenarios, validated with real-world data from multiple global locations.

### CROSS REFERENCE TO RELATED APPLICATIONS

This application claims priority to U.S. Provisional Application Ser. No. 63/653,648, filed on May 30, 2024, the entirety of which is incorporated herein for all purposes.

### BACKGROUND

Conventional probabilistic models that incorporate historical and present conditions have been used to forecast weather. However, such methods are not capable of reliably predicting rapidly changing weather events. Therefore, a need exists for enhanced techniques for forecasting rapidly changing weather conditions.

### BRIEF SUMMARY

Therefore, in one embodiment, a method for predicting weather conditions is set forth herein. In one embodiment, the method may include providing a forecasting model, the forecasting model comprising an extreme gradient tree boosting (XGBoost) classifier and at least one copula function. In another embodiment, the method may further include training the forecasting model using historical weather data. In a further embodiment, the method may further include predicting weather conditions by applying real-time data to the forecasting model. In yet another embodiment, the predicting may further include at least one of data clustering, data correlation analysis, synthetic data generation and data-driven modeling.

In other aspects of the present technique, systems may be used to implement the foregoing methods and related methods.

The above embodiments are exemplary only, and are not intended to limit the scope of the disclosure. Other embodiments as described herein are within the scope of the disclosed subject matter.

### BRIEF DESCRIPTION OF THE SEVERAL VIEWS OF THE DRAWINGS

So that the manner in which the features of the disclosure can be understood, a detailed description may be had by reference to certain embodiments, some of which are illustrated in the accompanying drawings. It is to be noted, however, that the drawings illustrate only certain embodiments and are therefore not to be considered limiting of its scope, for the scope of the disclosed subject matter encompasses other embodiments as well. The drawings are not necessarily to scale, emphasis generally being placed upon illustrating the features of certain embodiments. In the drawings, like numerals are used to indicate like parts throughout the various views, in which:

FIG. 1 depicts probabilistic forecasts obtained from the Persistence Ensemble method, in accordance with one or more aspects set forth herein;

FIG. 2 depicts a framework of an embodiment of a model for predicting rapidly changing weather events, in accordance with one or more aspects set forth herein;

FIG. 3 illustrates the rationale behind generating synthetic data by the proposed copula function classifier, in accordance with one or more aspects set forth herein;

FIG. 4 is a chart depicting the clustering results for different categories of data, in accordance with one or more aspects set forth herein;

FIGS. 5A and 5B depict the pair correlation of marginal distributions when modeling copula functions of each meteorological variable and GHI in an example cluster, in accordance with one or more aspects set forth herein;

FIG. 6 is an example of forecasts for a sunny day (with one-hour cloudy condition) and a following rainy day, in accordance with one or more aspects set forth herein;

FIG. 7 presents the hourly variability and central tendencies of GHI across seasonal intervals of the test data, in accordance with one or more aspects set forth herein;

FIGS. 8A & 8B depict forecasting comparisons of a model of the present technique and the QRMBLS model under various weather conditions, in accordance with one or more aspects set forth herein.

Corresponding reference characters indicate corresponding parts throughout several views. The examples set out herein illustrate several embodiments, but should not be construed as limiting in scope in any manner.

### DETAILED DESCRIPTION

The present disclosure relates to machine learning methods used to generate probabilistic weather forecasts. For instance, these weather forecasts demonstrates superior results under rapidly changing weather conditions when compared to conventional techniques. As explained in detail below, in various examples, the methods partition historical weather data into meteorological clusters to encompass all possible weather conditions, and make use of copula theory and machine learning. The techniques disclosed herein may be utilized by electric utility companies, transmission system operators, and the like, for operations and planning purposes, among other possible usages.

Generally stated, described herein, in one or more embodiments, is a method and system for probabilistic solar generation forecasting, addressing the limitations of conventional models in handling rapidly changing weather conditions. By combining copula theory with machine learning, the invention dynamically quantifies spatiotemporal correlations among meteorological variables. Historical weather data is clustered into meteorological categories (e.g., sunny, cloudy, rainy) using a grid-search method, and bivariate copulas identify optimal features via Kendall's tau and Spearman's rank correlations. Multivariable copulas (Vine and Gaussian) model variable dependencies, with an XGBoost classifier selecting the optimal copula based on real-time weather data. Synthetic data generated from the selected copula enhances forecast robustness, feeding into XGBoost regression trees trained with a Huber loss function to produce probabilistic solar power forecasts. The approach outperforms benchmarks like PeEn and QRMBLS by up to 60% in non-sunny conditions, validated with real-world datasets from Seattle and Yulara, enabling reliable grid operations and planning. As used herein, XGBoost refers to any gradient boosting machine learning technique. The Open Source XGBoost software-library is one such example, and a person of ordinary skill in the art would understand how to use this open source XGBoost software-library to implement the XGBoost functionality described herein.

By way of further explanation, probabilistic solar generation forecasting provides better means for quantification of the generation uncertainties for power grid operations and planning by providing a range of potential power outputs rather than a single point estimate. Conventional probabilistic models are unreliable under rapidly changing weather conditions due to fluctuating data correlations, necessitating dynamic modeling of spatiotemporal feature correlations under diverse weather scenarios. For example, these correlations represent the interactions across space and time that reflect the impact of weather conditions on solar power output. As explained herein, this critical problem is addressed with a novel method that combines copula theory and Machine Learning methods to dynamically quantify the spatiotemporal correlations among meteorological data under diverse weather conditions. The method employs, in one aspect, data clustering and copula-based feature selection to partition historical weather data into meteorological clusters that encompass all possible weather conditions. A variety of multi-variable copula functions are introduced to measure the spatiotemporal correlations among meteorological data within each cluster. Based on actual weather conditions, an Extreme Gradient Tree Boosting (XGBoost)-based classifier may be employed to identify the optimal copula functions that most accurately capture the inherent uncertainty of meteorological data. In one example, the optimal copula function is thus dynamically selected to generate synthetic weather data that contains data uncertainties corresponding to those specific weather conditions. In such a case, Probabilistic forecasts are generated using synthetic weather data. When tested on real-world datasets, the developed dynamic approaches set forth herein for modeling the spatiotemporal correlations outperforms state-of-the-art models by up to 60% higher accuracy under cloudy or overcast conditions.

As one example of the importance of this disclosure, dramatic increases in the integration of solar-powered generation units is anticipated to lead to substantial changes in power grids, necessitating improved operational and planning procedures. An accurate solar generation forecast is seen as a vital step in these operational enhancements and is especially critical for maintaining the real-time load and generation balance. Traditionally, the generation forecast is achieved using historical and present conditions, such as meteorological observations obtained from local weather stations or remote sensing devices. The resulting forecast provides grid operators with a short-term (day-ahead or hour-ahead) estimate of solar generation, allowing an optimized power dispatch, balancing the generated electricity and load, and preparing necessary measures to protect the grids from extreme events. Solar power forecasting can be performed deterministically or probabilistically. The probabilistic forecasts generate predicted values in the form of a probability distribution. In recent years, the research community and utilities have acknowledged the need for probabilistic predictions to integrate generation uncertainty quantification into grid operations and planning procedures. Previous research has also shown that probabilistic approaches outperform their deterministic counterparts in terms of cost and reliability. The focus of this disclosure is thus on probabilistic forecasting.

Probabilistic forecasting methods are classified into parametric techniques, in which the forecasted variable is expected to follow a prior distribution, and non-parametric approaches, in which no such assumptions are made. Parametric techniques refer to the sum of a deterministic forecast and a predefined distribution of the forecast error. In the category of the non-parametric probabilistic forecasts, Quantile Regression, and Persistence Ensemble (PeEn), are two widely used benchmarks.

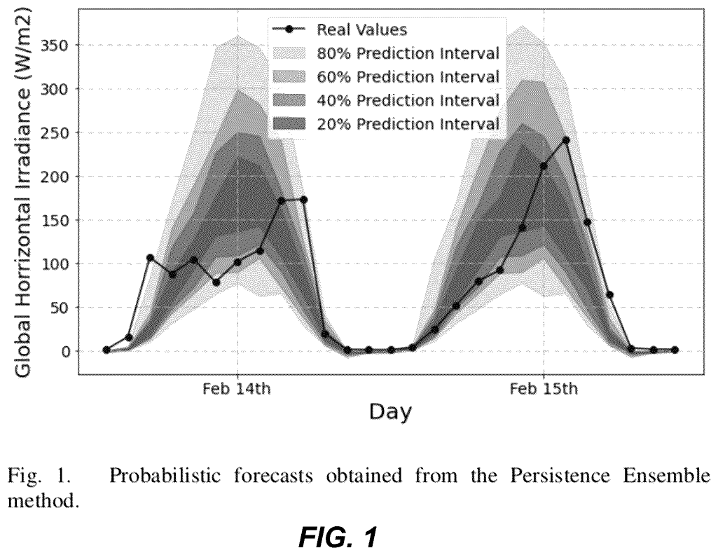

FIG. 1 illustrates an example of a probabilistic solar irradiance forecast from PeEn, from which some shortcomings of conventional probabilistic approaches for solar forecasts can be identified as follows: Conventional probabilistic forecasts are unable to adapt to sudden weather changes; often, forecasts for different days are nearly identical; and The Prediction Interval (PI) derived from traditional techniques is overly wide to be a credible reference for power system planning.

The techniques herein address the aforementioned issues through a novel integration of Copula theory and machine learning methodologies for an adaptive probabilistic forecast of solar generation. By dynamically modeling spatiotemporal correlations among meteorological variables and incorporating these correlations into probabilistic forecasts, a robust modelis developed. The developed model demonstrates robustness and accuracy in forecasting both solar irradiance and solar power across diverse weather conditions and multiple geographical locations worldwide.

In one example, the developed predictive model set forth herein dynamically models spatiotemporal correlations of meteorological variables based on weather conditions, thereby improving adaptability to rapidly changing weather situations. Case studies reveal that the developed model enhances forecast accuracy by up to 60% under non-sunny conditions compared to conventional methods.

An environment-aware model is developed to produce probabilistic forecasts that leverage the dynamically captured spatial-temporal correlations. This approach pre-trains multiple models, each designed for unique weather scenarios, with data incorporating spatio-temporal correlations relevant to those conditions. The selection of the appropriate model for forecast generation is based on the prevailing weather at the time of the forecast, thereby improving the model's adaptiveness to fluctuating meteorological conditions;

The effectiveness of embodiments of the disclosed model are evaluated for both hourly solar irradiance and solar power forecasting for every minute. Real-world data from diverse global locations are used for this purpose. The model outperforms established and recent benchmarks, such as PeEn, QR, in terms of accuracy and robustness nearly across all time periods.

Copulas were first introduced to probabilistic wind power forecasting in, to capture uncertainties in forecasting and later were applied to solar generation forecasting for the same purpose. The application of copula theory in renewable generation forecasting can be categorized in three ways: ) the development of a conditional probability distribution of generation given meteorological variables, 2) the analysis of the correlations between different variables, and 3) the generation of probabilistic forecasts using the ensemble approach.

In the first category, the copula-based joint probability distribution function (PDF) and Bayesian theory are generally utilized to form the conditional PDF of a renewable generation unit. For example, authors in apply copula theory to estimate the joint distribution of Global Horizontal Irradiance (GHI) forecast and solar generation output. Conditional probabilities for solar generation output are calculated using the obtained marginal and joint distributions. Similarly, in, Copula-Based conditional probabilistic forecast models are developed for predicting wind power and its ramp rate, respectively. In another work, the joint distribution between the forecasted and the real meteorological variables is modeled using copulas. A conditional PDF of weather scenarios given near real-time weather predictions is thus generated. The generated weather scenarios are used as input variables to a machine-learning model to produce probabilistic solar power forecasts. In, the prior distribution of the solar power forecasts is derived first using deterministic forecast models. Copula functions, which are constructed through the analysis of relationships between solar power output and temperature, are used to update the prior distribution to the posterior forecast distribution, thus providing probabilistic forecasts. Furthermore, Copula-based Quantile Nonlinear Regression (CQNR) is deployed by authors in for a day-ahead solar power forecast methodology. Given input variables v and predicted values x, the quantile equation with quantile level γ is formulated as:

$${Q}_{z} ( γ \vert v ) = {F}^{- 1} ( {C}_{x \vert v}^{- 1} ( γ \vert v ) ) \qquad ( 1 )$$

where the copula function C is used to optimize the quantile equation. In a similar work, Quantile-Copula is applied to probabilistic wind power forecasting. In, a copula-based autoregressive time series forecasting model is used to forecast solar irradiance. The time series are modeled using a pairwise decomposition of conditional distributions obtained from a copula, thus providing a flexible framework to generate synthetic series for generating forecasts. In, the time series of wind speed, which is used for generating forecasts, is classified into multiple non-Gaussian components through the Gaussian mixture copula model. The hybrid model developed in forms a joint probability distribution of solar power and weather variables using Copula theory and the Monotone Broad Learning System. The marginal probability distribution of the forecast, given certain input weather variables, can be generated from the joint probability distribution.

Despite the fact that the aforementioned works estimate copulas of renewable generation and meteorological variables, none of them dynamically investigates the impact of diverse variables on the generated forecasts. Since different variables under varying weather conditions have varying effects on forecasts, whether the aforementioned models can adapt to rapidly changing rapidly changing weather conditions remains to be debated. This study addressed this gap by thoroughly analyzing the dynamic correlation between meteorological variables, thus improving the accuracy and robustness of forecasts under rapidly changing weather conditions.

Another application of copula is for feature selection purposes, mainly to determine the optimal variables used for forecasting by analyzing the correlation between power generation and other variables. In, the relations between meteorological variables and solar power generation output are analyzed by the copula theory. The most relevant variables are then fed to a Long Short Term Memory Network (LSTM) to predict mid- to long-term (monthly or yearly) solar power. Similar work is proposed in, where suitable variables for the probabilistic solar forecast are determined by D-vine copulas after investigating the relationship between solar power and meteorological variables. Although this work demonstrated the promise of copula for feature selection, selecting a fixed set of optimal features for all weather scenarios is not persuasive for establishing a robust predictive model.

The adoption of copula theory for generating probabilistic forecasts has been demonstrated in several studies through the ensemble approach. For example, in, errors of deterministic forecasts are used to fit a D-vine copula. The generated probabilistic error from the well-trained copulas is thus added to the deterministic results to yield a probabilistic forecast. Similarly, Gaussian Copula is deployed in to form the distribution of the forecast error. In a different study, an ultra-fast pre-selection algorithm is deployed to select the optimal features, which are utilized by QR to yield initial forecasts. Initial forecasts from different sensors are used to train a copula function, which generates final probabilistic forecasts. In another work, historical meteorological data from the immediate past two weeks were first classified into groups. The data in each group is used to fit a copula function, which in turn generates synthetic weather data for generating probabilistic forecasts.

Despite the contributions of the aforementioned studies, they fail to fully consider the dynamic uncertainty inherent in meteorological variables under various weather conditions. More specifically, these studies tend not to adjust their methodologies and data to estimate spatiotemporal correlations among meteorological variables in response to changing weather conditions, which could result in suboptimal performance under rapidly changing weather scenarios. The present technique thoroughly addresses the problem by adeptly integrating Copula theory and data-driven forecast methods, which enables dynamic quantification of the spatiotemporal correlations among various variables. By effectively representing the intricate relationships between diverse variables under various weather conditions, the forecasting model's accuracy and robustness are significantly improved.

In statistics theory, copula theory is deployed to estimate the multivariate cumulative distribution function (CDF) of the input variables, thereby enabling an analysis of data correlations. More specifically, bi-variable copula functions are employed to identify the most relevant meteorological variables for generating accurate forecasts under diverse weather conditions. Multivariate copula functions are introduced to quantify the spatiotemporal correlations among meteorological variables.

According to the Sklar's theorem, the joint distribution F of variables X={x1, x2, . . . xₙ} with marginals Fi(xi) is formulated as:

$$F ( {x}_{1} , … , {x}_{n} ) = C ( {F}_{1} ( {x}_{1} ) , … , {F}_{n} ( {x}_{n} ) ) \qquad ( 2 )$$

However, the value of a CDF is in the range of zero to one. Hence, the input variables must be transformed to a standard uniform distribution, a procedure known as probability integral transform. Suppose a standard uniform distribution for variable xₙ is Uₙ=Fx, (xn), the probability integral transform is illustrated as:

$$\begin{matrix}{F}_{{U}_{n}} ( {u}_{n} ) = P ( {U}_{n} \leq {u}_{n} ) = P ( {F}_{{x}_{n}} ( {x}_{n} ) \leq {u}_{n} ) \\ = P ( {x}_{n} \leq {F}_{{x}_{n}}^{- 1} ( {u}_{n} ) = {F}_{{x}_{n}} ( {F}_{{x}_{n}}^{- 1} ( {u}_{n} ) ) = {u}_{n}\end{matrix} \qquad ( 3 )$$

where F_{Un} is the CDF of a uniformly distributed random variable, and Uₙ has a uniform distribution on the interval [0,1]. Thus, all the variables in X can be converted to uniform distributions:

$$( {u}_{1} , {u}_{2} , … {u}_{n} ) = ( {F}_{1} ( {x}_{1} ) , {F}^{2} ( {x}_{2} ) , … {F}_{n} ( {x}_{n} ) ) \qquad ( 4 )$$

The copula of the original variables X={x1, x2, . . . xₙ} is defined as the joint CDF of (U1, U2, . . . Uₙ):

$$C ( {u}_{1} , {u}_{2} , … {u}_{n} ) = P ( {U}_{1} \leq {u}_{1} , {U}_{2} \leq {u}_{2} , … , {U}_{n} \leq {u}_{n} ) \qquad ( 5 )$$

Suppose the joint distribution of (u1, u2, . . . uₙ) is H(u1, u2, . . . uₙ). There is a function C( ) that integrates the marginal distribution and the joint distribution, which can be expressed as:

$$H ( {u}_{1} , {u}_{2} , … {u}_{n} ) = C ( {F}_{1} ( {u}_{1} ) , {F}_{2} ( {u}_{2} ) , … {F}_{N} ( {u}_{n} ) ) \qquad ( 6 )$$

Based on the inverse transformation of a CDF of the marginal distribution, which refers to ui=Fi−1(ui), i=, 2, . . . N, the expression of the Copula function can be obtained:

$$C ( {u}_{1} , {u}_{2} , … {u}_{n} ) = H [ {F}_{1}^{- 1} ( {u}_{1} ) , {F}_{2}^{- 1} ( {u}_{2} ) , … {F}_{n}^{- 1} ( {u}_{n} ) ] \qquad ( 7 )$$

Upon obtaining the Copula function C( ) the joint density function of X is derived as:

$$\begin{matrix}f ( {x}_{1} , … , {x}_{n} ) = \frac{{\partial }^{2}}{\partial {x}_{1} \cdot … \cdot \partial {x}_{n}} C ( {u}_{1} , … , {u}_{n} ) \\ = {f}_{1} ( {x}_{1} ) \cdot … \cdot {f}_{n} ( {x}_{n} ) \cdot c ( {u}_{1} , … , {u}_{n} )\end{matrix} \qquad ( 8 )$$

$$c ( {u}_{1} , … , {u}_{n} ) = \frac{{\partial }^{2} C ( {u}_{1} , … , {u}_{n} )}{\partial {u}_{1} \cdot … \cdot \partial {u}_{n}}$$

Therefore, Copula functions enable the independent modeling of the marginal distributions and the dependency structure for random variables with unique marginal distributions. Copulas are classified into bivariate and multivariate Copulas. A bivariate Copula is a joint cumulative distribution function (CDF) of two random variables, and a multi-variate copula is used to model the joint CDF of multiple random variables.

The efficacy of copula functions is undermined when the input exhibits characteristics of singularity. In the event that the random variables X form a singular matrix, the corresponding U in (3) is also singular. The determinant of a singular matrix is zero, indicating that Ui is not invertible. As a result, the copula function C, as described in (7), cannot be obtained. The Ledoit-Wolf shrinkage method is thus introduced to address the problem.

Suppose U forms a singular matrix, and the corresponding covariance matrix is S. To aviod singularity, S is then updated using the Ledoit-Wolf shrinkage method as,

$${S}^{′} = ( 1 - ϵ ) \times S + ϵ \times trace ( S ) \qquad ( 9 )$$

where ∈ is the shrinkage parameter and ∈≈0.

Bi-variable copula-based Feature Selection:

Archimedean copulas constitute an associative class of copulas, with the Clayton, Frank, and Gumbel copulas being among the most widely utilized instances of this class. The copula function of the Clayton, Frank, and Gumbel copulas are denoted in (10)-(12) respectively.

$$C ( {u}_{1} , {u}_{2} ; α ) = {( {u}_{1}^{- α} + {u}_{2}^{- α} - 1 )}^{- \frac{1}{α}} ; α ∈ ( - 1 , ∞ ) \backslash \{ 0 \} \qquad ( 10 )$$

$$C ( {u}_{1} , {u}_{2} ; α ) = - \frac{1}{α} log ( 1 + \frac{( {ε}^{- α {u}_{1}} - 1 ) ( {e}^{- {αu}_{2}} - 1 )}{( {e}^{- α} - 1 )} ) ; α ∈ ( - ∞ , ∞ ) \backslash \{ 0 \} \qquad ( 11 )$$

$$C ( {u}_{1} , {u}_{2} ; α ) = exp ( - {[ {( - log ( {u}_{1} ) )}^{α} + {( - log ( {u}_{2} ) )}^{α} ]}^{\frac{1}{α}} ) ; α \geq 1 \qquad ( 12 )$$

In this research, the Maximum log-likelihood estimation (MLE) (13) is employed to estimate the dependence parameter.

$$ℓ ( α ) = arg max {\sum }_{i = 1}^{m} log ( c ( F ( {x}_{1} ) , F ( {x}_{2} ) ; α ) ) \qquad ( 13 )$$

In (13), F(x1) is the marginal CDF of the original feature x1. To evaluate the appropriateness of an Archimedean copula function in accurately capturing the dependence structure between two variables, the Bayesian Information Criterion (BIC) is deployed:

$$B I C = - 2 \times log ( c ( F ( {x}_{1} ) , F ( {x}_{2} ) ) + 2 \times log ( {N}_{s} ) \qquad ( 14 )$$

where Nₛ is the sample size of X.

The copula model differs from the traditional correlation analysis methods in that it does not limit the selection of marginal distributions. This flexibility allows for examining both linear and nonlinear associations between pairs of variables, as the copula function consistently estimates correlation values. Given a bi-variable copula, the Kendall's tau (15) and Spearman's rank correlation˜(16) coefficients are utilized here to analyze data correlations.

$$τ = 4 {\int }_{0}^{1} {\int }_{0}^{1} C ( {u}_{1} , {u}_{2} ) dC ( {u}_{1} , {u}_{2} ) - 1 \qquad ( 15 )$$

$$ρ = 12 {\int }_{0}^{1} C ( {u}_{1} , {u}_{2} ) {du}_{1} {du}_{2} - 3 \qquad ( 16 )$$

The applicability of the coefficients is broadened by the fact that they are independent of the marginal distributions of the variables, in contrast to linear correlation coefficients. These coefficients quantify the probability of simultaneous substantial increases or decreases in the random variables, providing a valuable measure of the strength and nature of the correlation between variables.

In this work, the correlation between each of the meteorological features and the solar power is analyzed using Kendall's tau coefficient and Spearman's rank correlation coefficient in (15) and (16), respectively, based on the obtained bi-variable copulas. Instead of determining one combination of optimal features, the optimal 2,3, . . . , n features are obtained for each cluster through the aforementioned data correlation analysis, where $n$ refers to the total number of features. Thus, 3×kᵢ×(n−1) numbers of optimal feature sets are obtained.

### Synthetic Data Generation

The generation of synthetic data aims to assess the spatio-temporal relationships among optimal feature sets, thereby quantifying the uncertainties within meteorological data that may not be apparent in original data but could emerge in future forecasting scenarios. The approach begins with developing multivariable copula functions for each optimal feature set and then selecting the best copula function to generate synthetic data related to prevailing weather conditions.

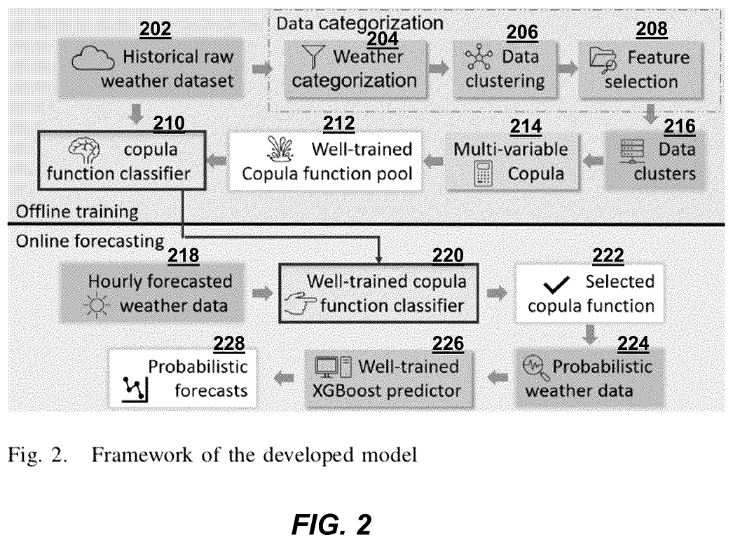

FIG. 2 illustrates the framework of the developed model for probabilistic solar generation forecasting under varying weather conditions. The process is divided into two main stages: offline training and online forecasting.

In the offline training stage, the process begins with a historical raw weather dataset (block 202), which is processed through a weather categorization module (block 204) to organize data. This is followed by a data clustering module (block 206) that partitions the data into meteorological clusters, and a feature selection module (block 208) identifies optimal meteorological features. A copula function classifier (block 210), trained using a well-trained copula function pool (block 212), generates multi-variable copula functions (block 214) to model spatiotemporal correlations, resulting in data clusters (block 216) for further analysis.

In the online forecasting stage, hourly forecasted weather data (block 218) is input into the well-trained copula function classifier (block 220), which selects an optimal copula function (block 222) based on real-time conditions. This selected function generates probabilistic weather data (block 224), which is processed by a well-trained XGBoost predictor (block 226) to produce probabilistic forecasts (block 228). The framework integrates dynamic copula selection and XGBoost regression to enhance forecast accuracy, particularly under rapidly changing weather conditions.

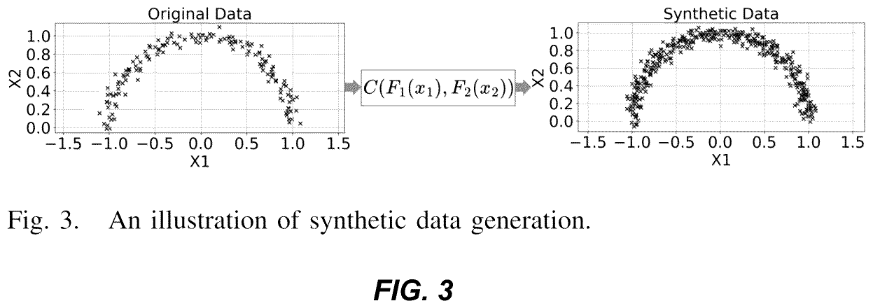

FIG. 3 demonstrates the rationale behind generating synthetic data. Initially, the process starts with using the data in optimal feature sets as the original data. Through the application of the copula function, additional synthetic samples are generated.

These samples represent uncertainties not captured in the initial data, and data expansion strengthens the model's ability to handle uncertainties. Training the model with both original and synthetic data refines its forecasting robustness, making it more resilient and adaptable to unforeseen variations in weather conditions.

Specifically, the dependence structure between variables in each aforementioned 3×kᵢ×(n−1) optimal feature set is estimated using multivariable copulas. Thus, joint CDFs can be obtained from multivariable copulas to generate synthetic meteorological data to incorporate the uncertainty of the weather conditions. Vine copula and Gaussian copula are introduced simultaneously in the research for such a purpose. The simultaneous integration of these distinct copula functions mitigates the limitations associated with the exclusive reliance on a single copula type, thereby enhancing model flexibility. The adaptability of the model is underscored by the selective application of either Vine or Gaussian copula, contingent upon the characteristics of the real-time weather conditions.

### Vine Copula

Vine copulas model dependencies among random variables by implementing a nested structure of bi-variate copulas, known as pair-copula.

The nested structure, and thus the relationship between the pair-copulas, determines the classification of the vine copula as either a C-vine, R-vine, or D-vine copula. We formulate the joint density function of variables X as D-vine, C-vine, and R-vine copulas in equations (17)-(19) respectively.

$$f ( {x}_{1} , ... , {x}_{n} ; α ) = [ {{\prod }_{j = 1}}^{\text{?} - 1} {{\prod }_{i = 1}}^{\text{?} - 1} {C}_{\text{?} , ... , \text{?} ; {α}_{i}} ] \cdot {{\prod }_{h = 1}}^{u} {f}_{h} ( {x}_{h} ) \qquad ( 17 )$$

$$f ( {x}_{1} , ... , {x}_{n} ; α ) = [ {{\prod }_{j = 1}}^{\text{?} - 1} {{\prod }_{i = 1}}^{\text{?} - 1} {C}_{j , \text{?} , ... , \text{?} ; {α}_{j}} ] \cdot {{\prod }_{h = 1}}^{u} {f}_{h} ( {x}_{h} ) \qquad ( 18 )$$

$$f ( {x}_{1} , ... , {x}_{n} ; α ) = {{\prod }_{h = 1}}^{α} {f}_{h} ( {x}_{h} ) \cdot {{\prod }_{j = 1}}^{\text{?} - 1} {\prod }_{\text{?}} {C}_{\text{?}} ( F ( {S}_{\text{?}} \vert {X}_{\text{?}} ) , F ( {X}_{\text{?}} \vert {X}_{\text{?}} ) \qquad ( 19 )$$

$$\text{?} \text{indicates text missing or illegible when filed}$$

The dependence parameter αj of each pair-copula is estimated using (13). In (19), e=j(e), and r(e)|D(e) is the combination that determines each pair-copula, and E is the combination set. The conditioning sets D and conditioned sets j, r are utilized to establish the order of the arguments within the pair copula.

Gaussian copulas model the dependence between variables as a Gaussian distribution. The correlation matrix of the multi-variate normal distribution is used as the parameter of the Gaussian copula to describe the dependence structure of the variables. The Gaussian copula function is denoted as:

$$C ( {u}_{1} , ... {u}_{n} ; p ) = {Φ}_{p} ( {Φ}^{- 1} ( {u}_{1} ) , ... , {Φ}^{- 1} ( {u}_{n} ) ) \qquad ( 20 )$$

Nevertheless, either Vine copula or Gaussian Copula has its limitations. Gaussian copula makes it hard to capture the tail structure, and Vine copula is inefficient for high-dimensional data.

This work introduces a novel solution to address the described research gap in comprehensively considering the volatile characteristics of weather conditions. The developed method applies the introduced types of multivariable copulas simultaneously, while the optimal copula is dynamically chosen based on future weather conditions at the time of the forecast. We apply an XGBoost classifier for this purpose. Thus, the spatio-temporal correlation between meteorological variables is dynamically quantified. XGBoost, a scalable machine learning algorithm based on ensemble tree boosting, excels in classification tasks. By aggregating multiple weak decision trees, XGBoost demonstrates resilience against data outliers. Given its robustness, XGBoost is well-suited for applications within this study, notably in scenarios where meteorological data may include outliers due to rapidly changing weather conditions.

In the developed method, four introduced types of multivariable copulas are utilized simultaneously, resulting in a total of 3×kᵢ×(n−1)×4 copula functions, thereby creating a comprehensive pool of copula functions, denoted as set C. An XGBoost-based classifier is then employed to identify and select the most suitable copula function from this pool based on the prevailing weather conditions. The classifier is trained using meteorological data X={x_1, . . . , x_n} as input features, and the copula functions C={C_1, . . . , C_3*k_i*(n−1)*4 as labels. During training, the optimal copula functions under prevailing weather conditions are pre-analyzed based on final forecasting performance, enabling the precise selection of appropriate functions for accurate weather condition analysis.

For the developed multi-class copula function classification problem, we formulate the prediction as:

$$\dot{C} = arg {max}_{j} {\sum }_{k = 1}^{k} {f}_{k , j} ( x ) \qquad ( 21 )$$

where fk (x) is the output of the k-th tree for class j (copula function j). The softmax function, defined as the loss function for each tree, is then applied in this study to convert raw predictions into probabilities.

$$L ( C , \dot{C} ) = - {\sum }_{j = 1}^{k} 1 ( C = \dot{J} ) log ( \frac{exp ( {\sum }_{k = 1}^{k} {f}_{k , j} ( x ) )}{{\sum }_{x = 1}^{k} exp ( {\sum }_{k = 1}^{k} {f}_{k , x} ( x ) )} ) \qquad ( 22 )$$

Aggregating trees and improving the model using the greedy method, we define the objective of the applied XGBoost as:

$$\{ \begin{matrix}{ℒ}^{( \text{?} )} = {\sum }_{i = 1}^{n} L ( {C}_{\text{?}} , {\hat{C}}_{l}^{( i - 1 )} + {f}_{\text{?}} ( {x}_{i} ) ) + Ω ( {f}_{\text{?}} ) \\ Ω ( {f}_{\text{?}} ) = η {X}_{\text{?}} + \text{?} μ {‖ {w}_{\text{?}} ‖}^{2}\end{matrix} \qquad ( 23 )$$

$$\text{?} \text{indicates text missing or illegible when filed}$$

where ft(x) is the independent regression tree with structure q and weights w at the t-th iteration. It is computationally challenging to list all tree structures in f(.) for optimization.

To simplify the calculation, the second-order Taylor expansion and the greedy algorithm are applied to add branches of trees for optimization iteratively. The objective function (23) can be simplified as:

$${ℒ}^{′} = \frac{1}{2} [ \frac{{( {\sum }_{i ∈ {X}_{\text{?}}} gi )}^{2}}{{\sum }_{i ∈ {X}_{\text{?}}} {h}_{i} + μ} + \frac{{( {\sum }_{i ∈ {X}_{\text{?}}} gi )}^{2}}{{\sum }_{i ∈ {X}_{\text{?}}} {h}_{i} + μ} - \frac{{( {\sum }_{i ∈ X} gi )}^{2}}{{\sum }_{i ∈ X} {h}_{i} + μ} ] - η \qquad ( 24 )$$

$$\text{?} \text{indicates text missing or illegible when filed}$$

where

$${g}_{i} = {\partial }_{\text{?}} l ( {y}_{i} , {\hat{y}}_{i}^{( l - 1 )} ) and {h}_{i} = {\partial }_{\text{?}}^{2} l ( {y}_{i} , {\hat{y}}_{i}^{( l - 1 )} ) .$$

$$\text{?} \text{indicates text missing or illegible when filed}$$

The objective L is thus readily optimized to. find the leaf weights of the entire tree.

The developed approach, summarized in Algorithm.1 allows for selecting the copula function that best captures the underlying dependencies between the meteorological features and the solar power, providing a more accurate representation of the complex relationships between these variables. The well-trained copula function classifier selects different well-trained copula functions for each time step in the forecasting process. The selected copula function is then employed to generate synthetic samples S, which are subsequently deployed for probabilistic forecasts.

Algorithm 1 Adaptive Selection of Copula Functions based on Weather Conditions
Leveraging XGBoost

```
  1: Input: Meteorological data X = {x₁, ... , xₙ}, 3 kᵢ × (n −
1) number of optimal feature sets
  2: Output: Trained XGBoost model, selected copula function Ĉ, synthetic samples
S
  3: Initialize pool of copula functions [symbol]
  4: for each optimal feature set do
  5: Estimate joint CDFs using Vine and Gaussian copulas
  6: Add all four well-trained copulas to [symbol]
  7: end for
  8: [symbol]   contains 3 × kᵢ (n − 1) × 4 copula functions
  9: for each meteorological data xᵢ ∈ X do
10: for each copula function Cⱼ ∈ [symbol]  do
11: Evaluate final forecasting accuracy using synthetic data generated from Cⱼ
12: end for
13: Find the best copula function for xᵢ
14: end for
15: Initialize XGBoost model with fₖ · j ees for each class j
16: for t ← 1 to T do
17: for each instance xᵢ ∈ X do
18: Compute gradient gᵢ and Hessian hᵢ for xᵢ
19: Update tree structures and leaf weights
20: end for
21: Aggregate trees, update model using greedy method
22: Optimize L⁽¹⁾with regularization term Ω (fₜ)_
23: end for
$24 : \hat{C} ← arg {max}_{j} {\sum }_{k}^{k} {=}_{1} {f}_{k} \cdot j ( x )$
25: Return trained XGBoost model
```

### Probabilistic Forecasting

An environment-aware model is developed to generate probabilistic forecasts using the synthetic data generated in the previous section. This model is integrated with the copula function classifier, enhancing its adaptability to fluctuating weather conditions by selecting appropriate data and models for forecast generation.

After the data-categorization step, 3*ki*(n−1) optimal feature sets corresponding to various weather scenarios are established. Each set is employed to train an individual XGBoost regression tree. The determination of the specific model for forecasting is guided by future weather conditions, as informed by the copula function classifier. A Huber loss function is employed for the XGBoost regression trees, which is defined as (25). Through the Huber loss function, the forecast model achieves robustness without compromising the precision essential for accurate prediction.

$${L}_{δ} ( y , p ) = \{ \begin{matrix}\frac{1}{2} {( y - p )}^{2} & for \vert y - p \vert \leq δ , \\ δ ( \vert y - p \vert - \frac{1}{2} δ ) & otherwise .\end{matrix} \qquad ( 25 )$$

The Huber loss function merges aspects of both mean squared error and mean absolute error, allowing for outlier impact mitigation and maintaining the model's predictive accuracy. The delta parameter establishes a threshold for applying quadratic loss, enhancing sensitivity to minor discrepancies.

During training, 3×kᵢ×(n−1)×4 copula functions are derived from 3×kᵢ×(n−1) optimal feature sets, resulting in the same number of synthetic sample feature sets. Each sample set, along with its corresponding original data, is used to train an XGBoost regression tree. A substantial number, specifically 3×kᵢ×(n−1)×4, of XGBoost regression trees are pre-trained. This pre-training process ensures that each model is finely tuned to accurately reflect the uncertainty captured by its feature set, enhancing the overall predictive accuracy in varying weather conditions. Through this comprehensive approach, the research leverages the dynamic nature of copula functions to provide a robust framework of weather-adaptive predictive modeling.

To generate forecasts using Numerical Weather Prediction (NWP) data, the trained XGBoost-based copula function classifier, and the trained XGBoost regression trees, the developed process is outlined as follows:

1) The trained copula function classifier uses the NWP data to select the best-fit copula function for future weather conditions; 2) The copula function determined in step is used to generate synthetic samples, denoted as S. The XGBoost regression tree that has been trained with feature types corresponding to those in S is selected; 3) Finally, S are used by the selected trained XGBoost regression tree to produce solar power forecasts. These forecasts are refined into probabilistic forecasts using the Gaussian Kernel Density Estimation in (26).

$$\hat{f} ( x ) = \frac{1}{nh \sqrt{2 π}} {\sum }_{i = 1}^{\text{?}} exp ( - \frac{{( x - {X}_{l} )}^{2}}{2 {h}^{2}} ) \qquad ( 26 )$$

$$\text{?} \text{indicates text missing or illegible when filed}$$

### Case Studies

The forecasting performance of the developed model is initially examined through solar irradiance predictions, where it is compared to benchmark models in both literature and industry. Subsequently, to further validate the model's effectiveness, the solar power data used in are utilized for comparative analysis.

The data used for solar irradiance forecasting were sourced from the Open Weather database and were gathered in Seattle, Washington, between January 2019, and Dec. 31, 2021. Meteorological data such as hourly temperature, zenith angle, dew points, feel-like temperature, air pressure, relative humidity, average wind speed, wind degree, cloud cover, and visibility are employed to forecast solar irradiance. The training dataset spans from January 2019, to Dec. 31, 2020, whereas the validation data is the last 20˜$\%$ of training data. The test dataset spans from January 2021, to Dec. 31, 2021.Following a comparison of the proposed model with benchmarks utilizing the aforementioned solar irradiance data, the proposed model's performance has been analyzed against benchmarks in the literature for solar power forecasting. The data used for solar power forecasting is identical to the dataset used in, spanning from 2017 to 2018 in Yulara, Australia. The meteorological data for solar power prediction comprises solar irradiance, temperature, wind direction, and wind speed, measured at 5-minute intervals. To ensure a fair comparison between the proposed model and the model, the training data is consistent with the data used to develop the model. Additionally, both models were evaluated using the same testing data from 2018.

To evaluate the probabilistic forecast, two statistical metric, i.e., the normalized Continuous Ranked Probability Score (nCRPS) (27) and the Pinball loss (28), are introduced.

$$nC R P S ( F , y ) = \frac{1}{{y}_{max}} {\int }_{- ∞}^{∞} {( F ( \hat{y} ) - {1}_{y \leq \hat{y}} )}^{2} d \hat{y} \times 100 \% \qquad ( 27 )$$

where F is the empirical CDF of the forecastsy\hat{ }. The nCRPS is similar to the normalized mean absolute error (nMAE) for a deterministic forecast. Pinball Loss is express as:

$$\hat{P} inball {Loss}_{\hat{γ}} ( y , \hat{y} ) = \{ \begin{matrix}( y - \overline{y} ) γ , & if y \geq \overline{y} \\ ( \hat{y} - y ) ( 1 - γ ) , & if \hat{y} > y\end{matrix} \qquad ( 28 )$$

Since γ refers to the quantile level, the Pinball loss is used to evaluate the accuracy of quantile forecasts. A lower CRPS or Pinball loss implies higher forecasting accuracy and a 0 value is regarded as a perfect result.

### Benchmark

The study utilizes benchmarks including PeEn, QR, and models introduced in prior research for a comprehensive comparative analysis. Specifically, the proposed model is compared with PeEn, QR, and the model in for hourly solar irradiance forecasting. For solar power forecasting on a 5-minute interval basis, the proposed model is compared against the model in. Next, these benchmarks are explained briefly.

A Hybrid Forecasting Model Combining Quantile Regression-based Monotone Broad Learning System (QRMBLS) with copula theory: In recent literature, authors in developed a comprehensive model that integrates QR, MBLS, and Copula theory, effectively merging probabilistic forecasts with the spatial-temporal correlations of meteorological variables through Gaussian Copulas. This model provides probabilistic solar power forecasts by generating joint probability distributions that incorporate both solar power and meteorological data, thus obtaining predictions based on forecasted meteorological data.

Generalized Laplace-based Long-short Term Memory Network (GL-LSTM): The model developed in is also used as the benchmark from recent literature for comparison. Authors in developed a modified LSTM network whose output adheres to a generalized Laplace distribution, incorporating an innovative loss function derived from the CRPS. The hyperparameters of the Generalized Laplace LSTM (GL-LSTM) model-such as learning rate, layer count, neurons per layer, and dropout rate-were rigorously optimized through a comprehensive cross-validation process, evaluating numerous parameter configurations to enhance model performance.

Persistence Ensemble: The persistence ensemble (PeEn) method, which is a traditional time series probabilistic forecasting method, is introduced as the first benchmark.

Quantile Regression: Another benchmark approach for forecasting, i.e., Quantile Regression (QR), is also introduced to compare with the developed model. The applied QR model is built with the same training data, and optimized with the cross-validation approach.

The analysis of the Data Categorization

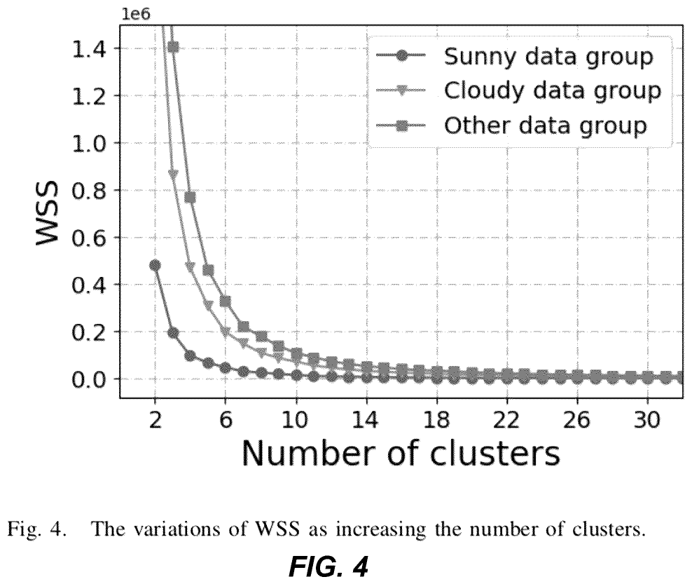

Historical weather data is first divided into three categories: sunny, cloudy, and other. Each data group is then subdivided into smaller clusters using the described clustering approach, enabling a more granular analysis of the relationships between variables within each group. To identify the optimal number of clusters, the grid-search method is applied based on the Within-Cluster Sum of Squares (WSS) (29), a metric used to evaluate the clustering performance. A lower WSS value indicates that the data points are closer to their respective centroids, suggesting a better clustering solution. The clustering performance is illustrated in FIG. 4.

$$W S S = {\sum }_{i = 1}^{k} {\sum }_{{x}_{j} ∈ {CT}_{l}} {‖ {x}_{i} - {x}_{{CT}_{l}} ‖}^{2} \qquad ( 29 )$$

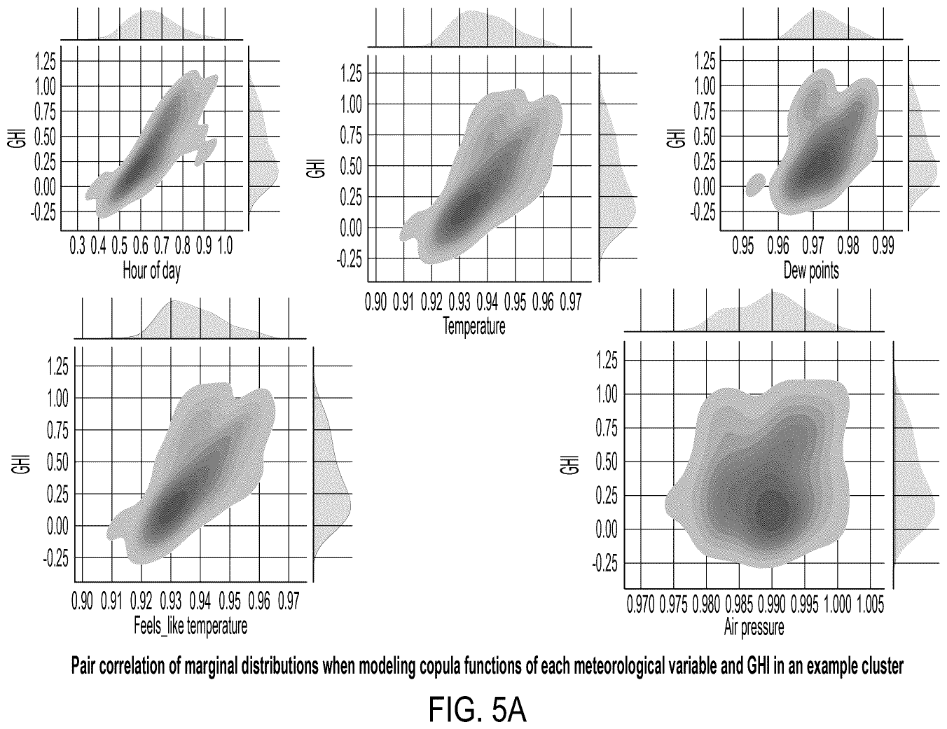

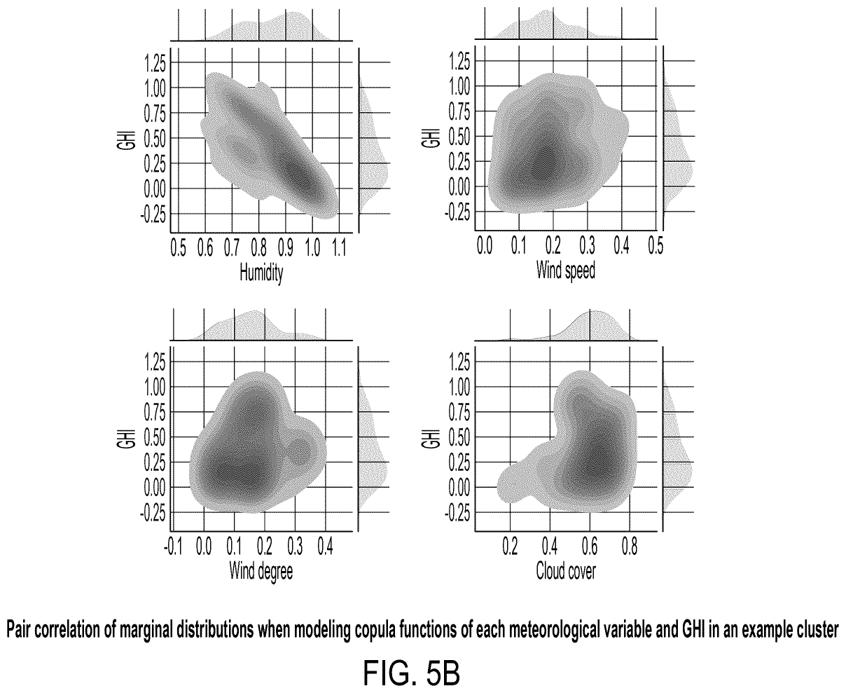

Upon determining the optimal number of clusters, the bi-variable copula-based approach is utilized to analyze the optimal features in each of the 3×ki clusters. For instance, consider a cluster of cloudy data where the pair correlation of marginal distributions of each variable and GHI is illustrated in FIG. 5. In this example, the hour of the day and temperature show a strong positive correlation, while humidity has a strong negative correlation with GHI. Kendall's τ and Spearman's rank ρ values corresponding to each variable are presented in Table I, where the variables' relevance is similar to that shown in FIG. 5. Consequently, the optimal features in each data cluster are chosen based on Kendall's τ and Spearman's rank ρ values.

TABLE I
KENDALL'S τ AND SPEARMAN'S RANK ρ
VALUES FOR DIFFERENT VARIABLE WITH GHI

| | | | Dew | Feel-like | |
|---|---|---|---|---|---|
| | Hour | Temperature | point | temp | Pressure |
| τ | 0.77 | 0.58 | 0.36 | 0.57 | 0.11 |
| ρ | 0.9 | 0.78 | 0.49 | 0.77 | 0.15 |

| | | Wind | Wind | Clouds |
|---|---|---|---|---|
| | Humidity | speed | degree | cover |
| τ | −0.58 | 0.15 | 0.12 | 0.09 |
| ρ | −0.75 | 0.2 | 0.22 | 0.13 |

After identifying various optimal feature sets for each cluster, a pool of copula functions is established. This pool is then utilized to train an XGBoost-based copula function classifier, which is for future forecasting purposes as illustrated in FIG. 2. The well-trained copula function classifier is employed to dynamically select a well-trained copula function, used to generate probabilistic weather data for yielding forecasts in real time.

### The Copula Function Classifier

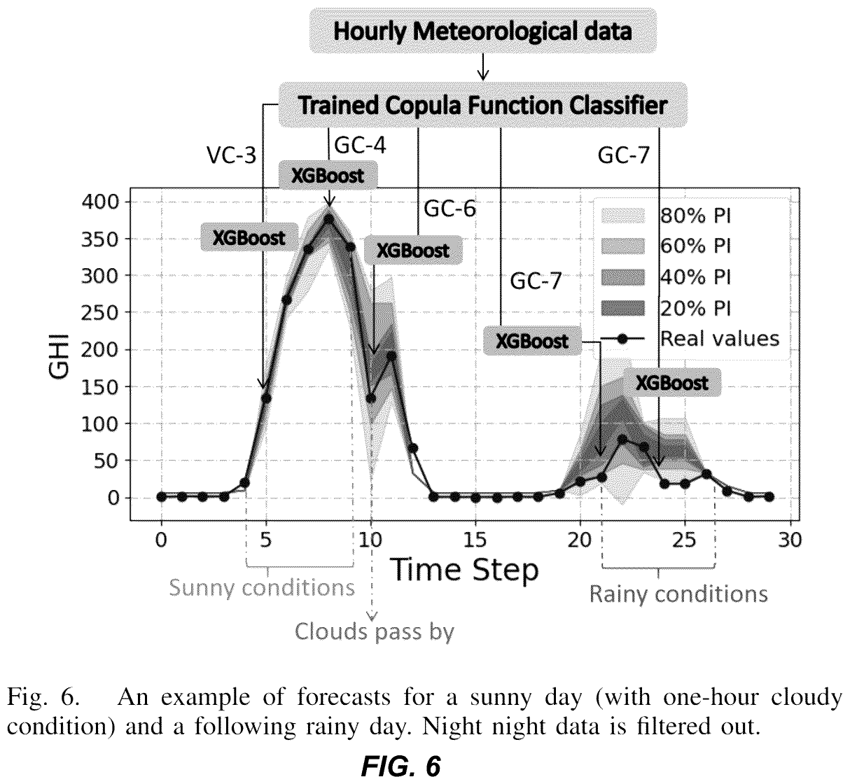

The hyperparameters of the XGBoost classifier utilized in this study are refined through cross-validation, setting the learning rate at 0.001, the maximum tree depth at 6, and employing L2 regularization to prevent over-fitting by penalizing model complexity. An illustrative example of the forecasts and the dynamically selected optimal copula function for each time step is presented in FIG. 6, where night-time data has been excluded, as previously mentioned.

FIG. 6 shows solar irradiance forecasts for a sunny day, including an hour of cloudy conditions and a following rainy day. It illustrates how the trained copula function classifier selects an appropriate copula function for each time step based on hourly meteorological data. The labels “VC-3” and “GC-7” represent the Vine and Gaussian copula functions, estimated using three and seven meteorological features, respectively. The trained XGBoost regression trees use synthetic samples derived from these copula functions to produce probabilistic forecasts. The specific XGBoost regression tree applied varies with each time step, tailored to the copula function selected for diverse weather conditions.

This example highlights the adaptability of the forecasting model to different weather conditions by dynamically adjusting the data and functions used to estimate the spatio-temporal correlation between meteorological variables. It also demonstrates that an accurate forecast requires fewer features under stable weather conditions, e.g., sunny weather, and more under unstable conditions, e.g., cloudy or rain. The forecasts show the preference for Vine copula functions when fewer features are involved, aligning with their effectiveness in lower-dimensional data scenarios, whereas Gaussian copula functions are chosen as the data dimensions increase.

Comparison with Benchmark Models for Day-ahead Hourly Solar Irradiance PredictionThe forecasting performance of the proposed model is compared to the benchmark methods. Various models generate day-ahead hourly solar irradiance forecasts, and their performance is evaluated based on nCRPS and Pinball loss metrics. Table˜\ref{table: compare} compares the developed model with benchmark models, including “no-CC” (the proposed model without copula classifier), “no-VineC” (the proposed model without Vine copulas, only using Gaussian copulas), PeEn, QR, and the GL-LSTM developed in. The developed model consistently outperforms other models in terms of nCRPS and Pinball loss, achieving the lowest forecasting error across all periods except for July-August, where the GL-LSTM model shows a slightly better performance in nCRPS. Nonetheless, whereas the proposed model's forecasts are slightly improved compared to the GL-LSTM model, its superiority becomes more pronounced under non-sunny or rapidly changing weather conditions. This advantage is further elucidated in the subsequent section, highlighting the robustness and effectiveness of the developed model across a broader range of meteorological scenarios. The improved accuracy of the developed model can be attributed to the effective combination of the copula classifier and multiple types of copulas. This combination allows the model to better account for the complex relationships between variables under diverse weather conditions.

The comparison of the proposed model with its modified versions, i.e., “no-CC” and “no-VineC” cases, emphasizes the significance of both the copula classifier and the application of multiple types of copulas within the overall forecasting framework. By selecting the optimal copula function from among Vine copulas and Gaussian copulas, instead of solely relying on one type of copula, the model attains the flexibility to represent a wide range of variable dependencies. Furthermore, such a structure enhances the robustness of the model to variations in meteorological data and improves the forecast accuracy.

TABLE II
THE COMPARISON OF THE DEVELOPED MODEL WITH BENCHMARK
MODELS IN TERMS OF PREDICTION PERFORMANCE

| | January- | March- | May- | July- | September- | November- |
|---|---|---|---|---|---|---|
| | February | April | June | August | October | December |
| nCRPS | | | | | | |
| proposed | 5.2 | 6.8 | 6.7 | 6.7 | 5.9 | 6.3 |
| no CC* | 6.2 | 7.4 | 7.1 | 7.4 | 6.3 | 7.4 |
| no VineC* | 5.7 | 7.6 | 7.3 | 7.2 | 6.6 | 6.7 |
| PeEn | 8.8 | 10.5 | 9.5 | 9.2 | 9.6 | 9.1 |
| QR | 7.2 | 9.8 | 10.2 | 9.8 | 8.3 | 7.4 |
| GL-LSTM^{[39]} | 5.6 | 7.1 | 7.3 | 6.6 | 7.7 | 6.4 |
| Pinball loss | | | | | | |
| proposed | 21.5 | 45.1 | 52.6 | 46.8 | 34.1 | 17.3 |
| no CC* | 22.2 | 47 | 53.2 | 49.6 | 34.9 | 18 |
| no VineC* | 22.4 | 45.3 | 54.3 | 48.2 | 34.2 | 17.9 |
| PeEn | 50.4 | 87.2 | 85.7 | 80.1 | 56.9 | 35.8 |
| QR | 35.8 | 78.2 | 92.1 | 83.1 | 54.4 | 26.4 |
| GL-LSTM^{[39]} | 25.2 | 49.2 | 56.5 | 48.2 | 37.7 | 17 |

*no -CC refers to the case of removing the copula classifier step in the proposed model. A fixed optimal feature set and a fixed type of copala function is applied to all weather conditions.
*no -VineC refers to removing the application of Vine-copula in the proposed model, only using Gaussian copulas.

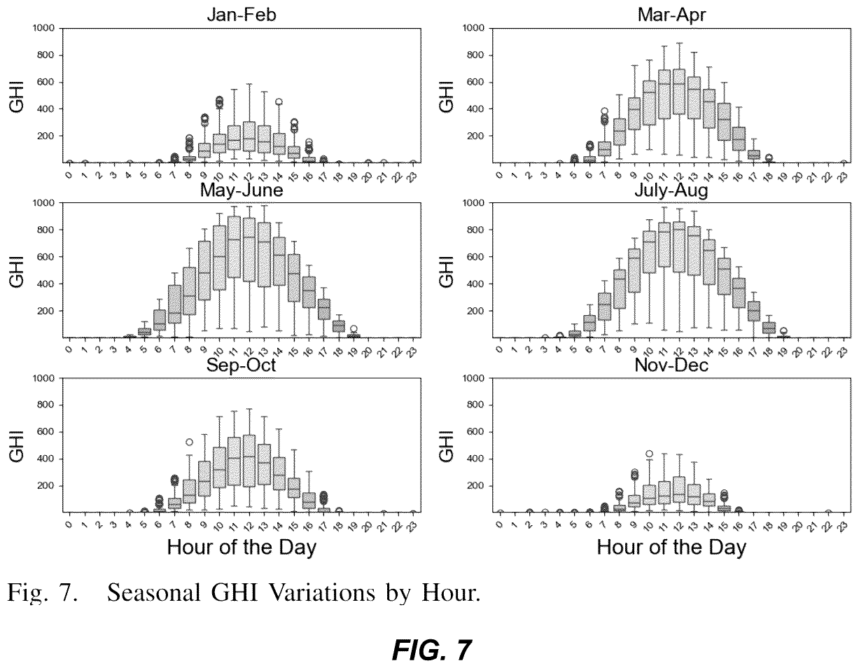

FIG. 7 presents the hourly variability and central tendencies of GHI across seasonal intervals, corresponding to the test dataset employed for error computation in Table.II. This visualization underscores the pronounced impact of seasonal shifts on solar irradiance and corroborates the robustness of the proposed model under diverse meteorological scenarios.

In Table III, the time for offline training and online forecast for various models are documented. The computational experiments were executed on a system equipped with a2th Gen Intel(R) Core™ i7-12700H CPU, 2300 MHz, and 4 cores and complemented by 6 GB of RAM. It is observed that offline training for the developed model is more extensive than other models; however, this process is a one-time requirement. In online forecasting, the developed model, albeit requiring a longer duration, completes the task in around eight seconds, which is deemed satisfactory for near real-time applications.

TABLE III
RUNNING TIME OF OFFLINE TRAINING AND ONLINE
FORECASTING OF DIFFERENT MODELS

| | Developed | GL-LSTM | QR | PeEn |
|---|---|---|---|---|
| Offline training (s) | 11980 | 3780 | 20 | 1 |
| Online forecasting (s) | 8.2 | 1.2 | 0.02 | 0.0006 |

### Comparison with the Benchmark Model for Day-ahead Minutely Solar Generation Prediction

To further validate the proposed model's robustness under diverse weather conditions, solar power data from are employed for a comparative study with models presented in[39], representing advanced models in recent literature.

To ensure an equitable comparative analysis, the model in is replicated with meticulous adherence to its specifications described in the paper, utilizing identical data and hyperparameters as delineated in. Further details on these parameters are accessible in.

The model developed in considers spatio-temporal correlations of meteorological variables for solar power forecasting, integrating Copula theory and machine learning methodologies. This methodology distinguishes between sunny and non-sunny days to independently quantify spatio-temporal correlations for each category. However, this distinction overlooks the variability within each category, as sunny days may experience non-sunny intervals and vice versa. Thus, the model does not dynamically analyze data correlations under fluctuating weather conditions, compromising forecast accuracy during rapidly changing weather conditions. The comparative analysis highlighted in this section demonstrates the superior performance of the developed model, which is based on dynamic spatio-temporal correlation analysis, thereby confirming its increased accuracy and flexibility.

The dataset utilized in this case study is the same as the data employed, which can be found in. For a consistent comparison, both the training and test datasets for the developed model are the same as those used in.

TABLE IV
THE COMPARISON OF THE DEVELOPED
MODEL WITH BENCHMARKS

| | Spring | | Summer | | Autumn | | Winter | |
|---|---|---|---|---|---|---|---|---|
| | Sun- | Oth- | Sun- | Oth- | Sun- | Oth- | Sun- | Oth- |
| | ny* | er* | ny | er | ny | er | ny | er |
| nCRPS (100%) | | | | | | | | |
| proposed | 1.6 | 3.56 | 1.6 | 2.7 | 1.1 | 1.7 | 1.6 | 3.2 |
| model in [19] | 1.7 | 7.3 | 2.0 | 4.7 | 2.5 | 5.4 | 2.4 | 7.3 |
| model in [39] | 1.67 | 5.25 | 1.1 | 4.5 | 1.6 | 3.3 | 1.8 | 5.8 |
| Pinball loss | | | | | | | | |
| proposed | 3.45 | 5.62 | 3.45 | 4.73 | 1.63 | 3.36 | 3.29 | 5.2 |
| model in [19] | 3.5 | 9.2 | 2.3 | 6.3 | 2.4 | 6.7 | 2.8 | 9.0 |
| model in [39] | 2.35 | 8.7 | 1.6 | 7.6 | 2.0 | 5.1 | 2.6 | 8.68 |

*Sunny refers to sunny days, which may include non-sunny conditions.
*Other refers to Non-sunny days, which may include sunny conditions.

Table IV presents a performance comparison between the proposed model and the model in and GL-LSTM for different seasons and varying weather conditions. The results indicate that the proposed model generally outperforms the model in and GL-LSTM, with much more accurate forecasts during non-sunny days. For sunny-day forecasts, the proposed model demonstrates comparable accuracy to the model and GL-LSTM in spring and summer while outperforming these models during autumn and winter, when weather conditions tend to be more unstable.

In the case of non-sunny day forecasts, the proposed model significantly outperforms the model, with the proposed model demonstrating up to 60% greater accuracy during autumn. These findings further highlight the ability of the proposed model to enhance the robustness and reliability of solar generation forecasting in various weather conditions. The superior performance of the proposed model is enabled by the ability to dynamically quantify the correlation between different meteorological variables under various weather conditions.

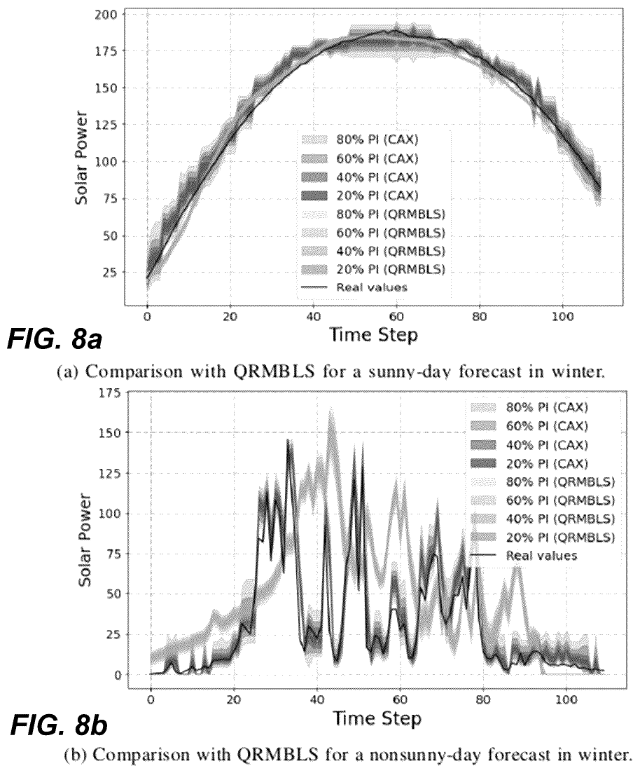

FIG. 8 compares the proposed model, and the model described in, focusing on performance under rapidly changing weather conditions to underscore the effectiveness of our approach. Specifically, the figure illustrates forecasts for a day of heavy rainfall, generally categorized as a rare event based on its infrequency. Accurate forecasting during such rapidly changing weather conditions is crucial due to their significant potential impact on the stability and normal operation of power systems. While advanced models cited in existing literature often struggle to provide robust and precise forecasts under such challenging conditions, the proposed model demonstrates exceptional capability in predicting solar generation. This is especially noteworthy when precise forecasts are essential for ensuring the resilience and stability of power systems.

### Conclusion

In this work, a non-parametric model based on Copula theory and XGBoost is developed for probabilistic forecasting. Unlike traditional approaches that focus on identifying a single type of optimal copula function, the developed model concurrently examines multiple copula functions and selects the most suitable one according to forecasted weather conditions. This flexibility enables the model to capture the varying dependencies of meteorological variables better. By dynamically analyzing the spatio-temporal correlations of meteorological variables under diverse weather conditions, the proposed model enhances forecasting accuracy and robustness, particularly in rapidly changing weather situations when accurate forecasts are challenging.

Case studies employing real-world data from various locations and time intervals demonstrate that the developed model can substantially improve prediction accuracy when compared to benchmark models such as PeEn, QR, the GL-LSTM, and the model in, especially for non-sunny days. Furthermore, the model is adaptable to rapidly changing weather conditions, providing grid operators with valuable insights for reliable grid operations. The feasibility of the developed model has been tested in a real-world application during the 2022 American-Made Solar Forecasting Prize where it secured the runner-up place and showcased its practical applicability for enhancing solar power forecasting.

By way of example, the present techniques, including the aforementioned forecasting framework that utilizes machine learning (ML) for dynamic feature selection, significantly enhances the precision and adaptability of solar irradiance forecasting. Unlike traditional static methods, this innovative system dynamically identifies the most relevant meteorological features in real-time, adeptly responding to rapidly changing and extreme weather conditions. It also employs advanced synthetic data generation to augment limited historical datasets, markedly improving predictive accuracy during rare, high-impact events such as winter storms, wildfires, or heatwaves. This dual approach ensures robust forecasting performance, even in unprecedented scenarios, by continuously learning from real-time data and adjusting to environmental shifts. The framework's scalability and flexibility make it a versatile solution for applications ranging from small-scale solar installations to large-scale utility operations, addressing critical market gaps in adaptive forecasting, data scarcity, and automated feature selection, thus providing a competitive edge in the renewable energy sector.

What is claimed is:

1. A method for probabilistic forecasting of solar generation under varying weather conditions, the method comprising:
providing a forecasting model comprising an extreme gradient tree boosting (XGBoost) classifier and a plurality of copula functions, the plurality of copula functions including at least one bivariate copula and at least one multivariable copula selected from a group comprising Vine copulas and Gaussian copulas;
training the forecasting model using historical weather data, wherein the training comprises
partitioning the historical weather data into a plurality of meteorological clusters based on weather conditions using a clustering algorithm,
determining, for each meteorological cluster, a set of optimal meteorological features by analyzing spatiotemporal correlations using the at least one bivariate copula,
generating a plurality of multivariable copula functions for each set of optimal meteorological features to model dependencies among meteorological variables, and
training the XGBoost classifier to select an optimal copula function from the plurality of multivariable copula functions based on prevailing weather conditions;
generating synthetic weather data using the optimal copula function selected by the XGBoost classifier, wherein the synthetic weather data represents uncertainties in meteorological variables; and
producing a probabilistic solar generation forecast by applying the synthetic weather data to a trained XGBoost regression tree corresponding to the optimal copula function.

2. The method of claim 1, wherein partitioning the historical weather data comprises categorizing the historical weather data into at least three weather categories, the categories including sunny, cloudy, and one of rainy or snowy, and subdividing each category into smaller clusters using a grid-search method based on Within-Cluster Sum of Squares (WSS).

3. The method of claim 1, wherein determining the set of optimal meteorological features comprises calculating rank correlation coefficients using the at least one bivariate copula to identify correlations between meteorological variables and solar power output.

4. The method of claim 1, wherein generating the synthetic weather data comprises applying the optimal copula function to produce synthetic samples that capture spatiotemporal correlations not present in the historical weather data.

5. The method of claim 1, wherein the probabilistic solar generation forecast is refined using Density Estimation to generate a probability distribution of solar power output.

6. The method of claim 1, wherein the XGBoost regression tree is trained using a loss function to enhance robustness against outliers in the meteorological variables.

7. The method of claim 1, wherein the forecasting model addresses singularity in meteorological data by applying a shrinkage method to update a covariance matrix of the meteorological variables.

8. A system for probabilistic forecasting of solar generation under varying weather conditions, comprising:
a data storage device configured to store historical weather data;
a processor communicatively coupled to the data storage device;
a memory storing instructions that, when executed by the processor, cause the system to:
implement a forecasting model comprising an extreme gradient tree boosting (XGBoost) classifier and a plurality of copula functions, the plurality of copula functions including at least one bivariate copula and at least one multivariable copula selected from a group comprising Vine copulas and Gaussian copulas;
train the forecasting model by: partitioning the historical weather data into a plurality of meteorological clusters based on weather conditions using a clustering algorithm; determining, for each meteorological cluster, a set of optimal meteorological features by analyzing spatiotemporal correlations using the at least one bivariate copula; generating a plurality of multivariable copula functions for each set of optimal meteorological features to model dependencies among meteorological variables; and training the XGBoost classifier to select an optimal copula function from the plurality of multivariable copula functions based on prevailing weather conditions;
generate synthetic weather data using the optimal copula function selected by the XGBoost classifier, wherein the synthetic weather data represents uncertainties in meteorological variables; and
produce a probabilistic solar generation forecast by applying the synthetic weather data to a trained XGBoost regression tree corresponding to the optimal copula function.

9. The system of claim 8, wherein the memory further stores instructions to partition the historical weather data by categorizing the historical weather data into at least three weather categories, the categories including sunny, cloudy, and one of rainy or snowy, and subdividing each category into smaller clusters using a grid-search method based on Within-Cluster Sum of Squares (WSS).

10. The system of claim 8, wherein the memory further stores instructions to determine the set of optimal meteorological features by calculating rank correlation coefficients using the at least one bivariate copula to identify correlations between meteorological variables and solar power output.

11. The system of claim 8, wherein the memory further stores instructions to generate the synthetic weather data by applying the optimal copula function to produce synthetic samples that capture spatiotemporal correlations not present in the historical weather data.

12. The system of claim 8, wherein the memory further stores instructions to refine the probabilistic solar generation forecast using Density Estimation to generate a probability distribution of solar power output.

13. The system of claim 8, wherein the memory further stores instructions to train the XGBoost regression tree using a loss function to enhance robustness against outliers in the meteorological variables.

14. The system of claim 8, wherein the memory further stores instructions to address singularity in meteorological data by applying a shrinkage method to update a covariance matrix of the meteorological variables.

15. The system of claim 8, further comprising a communication module configured to receive real-time numerical weather prediction (NWP) data, wherein the processor is configured to use the NWP data to select the optimal copula function for generating the synthetic weather data.
